(19) United States
(12) Patent Application Publication
(10) Pub. No.: US 2002/0153664 A1
(43) Pub. Date: Oct. 24, 2002

(54) Media isolation seal system

(76) Inventor: John W. Schroeder, Orange, CA (US)

Correspondence Address: WALTER A. HACKLER, Ph.D., Attorney For Record, Suite B, 2372 S.E. Bristol,, Newport Beach, CA, 92660-0755, US

(21) Appl. No.: 10/127,136

(22) Filed: Mar. 26, 2002

Related U.S. Application Data
(60) Provisional application No. 60/279,338, filed on Mar. 28, 2001.

(51) Int. Cl. F16J 15/32

(52) U.S. Cl. 277/551

(57) ABSTRACT

A media isolation seal system for sealing between a housing and a shaft to prevent passage of pressurized abrasive media includes a floating seal disposed between the housing and the shaft for contact the pressurized abrasive media and preventing passage other media thereby. A rear seal disposed between the housing and the shaft at a spaced apart distance from the floating seal as provided along with a lubricating fluid disposed between the floating seal and the rear seal for transferring pressure to the rear seal and enabling the floating seal to have a zero differential there across.

Present invention is generally related to sealing systems and more particular related to a media isolation seal system which utilizes a plurality of seals mounted in a housing or on a shaft and are designed to prevent an abrasive fluid from passing across the seals.

Sealing applications with harsh conditions, such as in the oil drilling industry, are particularly challenging. Such as seals are required to protect the delicate and expensive electronic down hole equipment used for monitoring and control in such operations.

Heretofore, technology for such applications utilized various elastomeric packings often with a polymeric front seal for excluding the harsh media. Harsh media typically includes abrasive drill mud on one side of the seal and hydraulic oil on another side of the seal with environmental pressures up to 25,000 PSI which effect a pressure differential across the seal up to 1,000 PSI alternating either direction with temperatures as high as 350° F.

The polymeric/elastomeric seal technology has proven to have relatively short life and usually results in random failures which are costly to the operation.

The present system can withstand harsh conditions of abrasive medium and very high temperatures while providing exceptional sealing life for both reciprocating, rotary and/or static applications.

### SUMMARY OF THE INVENTION

A media isolation seal system in accordance with the present invention for sealing between a housing and a shaft to prevent passage of pressurized abrasive media generally includes a floating seal disposable between the housing and the shaft for contacting the pressurized abrasive media and preventing passage of media thereby. A rear seal is disposed between the housing and the shaft in a spaced apart distance from the floating seal and a lubricating fluid is disposed between the floating seal and a rear seal for transferring pressure to the rear seal and enabling the floating seal to have zero pressure differential there across. The fluid provides lubrication for the seals which increases service life.

More particularly, the floating seal and the rear seal may comprise a spring-loaded lip seal which are oriented between the housing and the shaft with the lips facing the pressurized media. A second rear seal may be provided in a abutting relationship with the rear seal for providing bi-directional sealing at the rear seal position.

The second rear seal may be an o-ring seal or a spring loaded lip seal oriented back-to-back with lip seals having lips extending in opposite directions.

Alternatively, the rear seal may include a plurality of seals in tandem which may be spring loaded lip seals.

Further, a floating labyrinth clearance seal may be disposed on the pressure side of the floating seal.

In another embodiment of the present invention a cartridge is provided for supporting the floating seal and a rear seal in a spaced apart relationship. The cartridge may include a housing portion and a snap-on washer for securing the housing portion to the housing and may further include a sleeve portion for abutting a shaft.

### BRIEF DESCRIPTION OF THE DRAWINGS

The advantages and features of the present invention will be better understood by the following description when considered in conjunction with the accompanying drawings in which:

FIG. 1 is a cross section representation of one embodiment of the present invention generally showing a housing, hollow shaft, a floating seal in a spaced apart relationship with a rear seal and a center lubricating fluid to transfer pressure to the rear seal;

FIG. 2 is a cross sectional view similar to FIG. 1 also showing a second rear seal in the form of an o-ring along with a retaining ring;

FIG. 3 is a cross sectional view similar to that shown in FIG. 1 with the retaining ring being coupled to the rear seal;

FIG. 4 is another embodiment to the present invention illustrating the use of two abutting rear lip seals which are coupled or snapped together;

FIG. 5 is an alternative embodiment to the present invention illustrating the seal arrangement between a housing an a solid shaft with a floating seal and two rear lip seals along with retaining washers and spiral retaining rings;

FIG. 6 is another embodiment of the present invention further including the use of a cartridge for separating the floating seal and the rear seals;

FIG. 7 is yet another embodiment of the present invention similar to FIG. 6 but further including as a cartridge a sleeve portion on a shaft;

FIG. 8 is yet another embodiment of the present invention utilizing a floating barrier lip seal and two rear back-to-back pressure lip seals to give bi-directional sealing at a rear seal position which is configured in a cartridge between a housing and a piston;

FIG. 9 is an alternative embodiment of the present invention similar to FIG. 8 using auxiliary static o-ring seals on the cartridge;

FIG. 10 is another embodiment utilizing a separate cartridge for retaining a pair of rear seals and a spiral retaining ring for retaining the floating seal;

FIG. 11 is an alternative embodiment of the present invention utilizing a plurality of rear seals in tandem;

FIG. 12 is yet another embodiment of the present invention further including a labyrinth clearance seal disposed in front of the front floating seal for further extending life of the seal system;

FIGS. 13A-13G show variations of specific designs of seal elements in accordance with the present invention which may be substituted for the seal elements shown in FIGS. 1-12.

### DETAILED DESCRIPTION

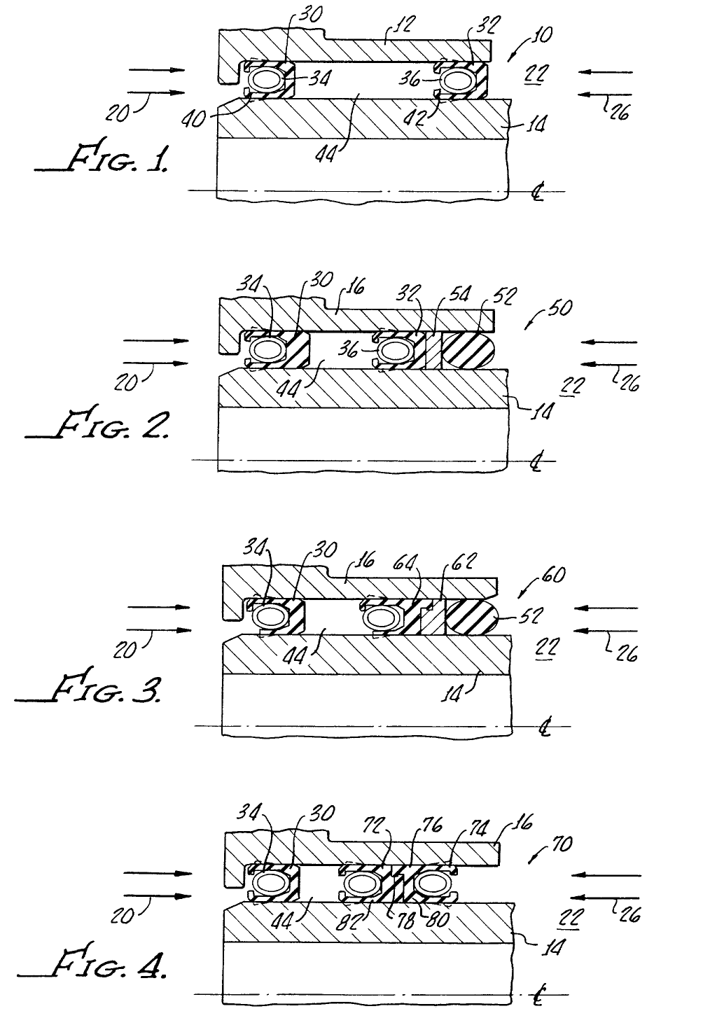

With reference to FIG. 1, there is shown a media isolation seal system 10 in accordance with the present invention for sealing between a housing 12 and a hollow shaft 14 to prevent passage of pressurized abrasive media, such as drilling mud, represented by the arrows 20, past the seal system 10 and into fluid, such as hydraulic oil, 22.

As hereinabove noted the environmental pressures of the sealing system 10 are very high, for example up to 25,000 PSI with pressure differential across the sealing system 10 often in the order of 1,000 PSI which also may alternate as represented by the arrows 26.

Materials of construction of the seal system 10 are selected to withstand temperatures as high as 350° F. The system 10 includes a floating seal 30 disposed between the housing 12 and shaft 14 for facing the abrasive media, indicated by the arrows 20, along with a rear seal 32 disposed between housing 12 and the shaft 14 and at a spaced apart distance from the floating seal 30.

As shown the seals 30, 32 may be lip seals of a design set forth in U.S. Pat. Nos. 4,655,462, 4,830,344 and 5,265,890 all to Ballsels. These cited patents are incorporated herewith into the present applications in their entirety for providing examples of lip seal design and spring 34, 36 loading thereof. In FIG. 1, lip portions 40, 42 of the seals 30, 32 are oriented toward the drilling mud, represented by the arrows 20.

A lubricating fluid 44 is disposed between the floating seal 34 and the rear seal 36 for transferring pressure indicated by the arrows 20 to the rear seal 36 and thus enabling the floating seal 34 to have zero differential pressure there across.

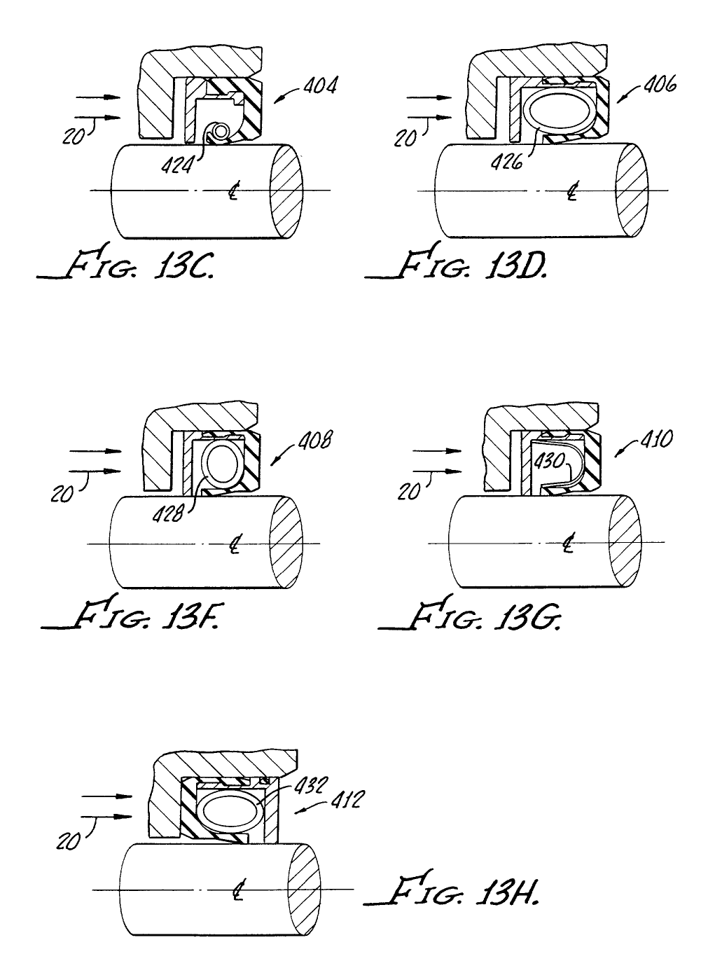

The U-cup-type lip seals 30, 32 may use canted coil springs 34, 36, or other type energizing springs (see FIGS. 13C and 13G) and may be of various types, such as hereinafter described in greater detail. Accordingly, the seal system 10 isolates the harsh media 20 from the hydraulic fluid 22 and has long life due to the lubricating of the floating and rear seal 30, 32 by the fluid 44.

With reference to FIG. 2, there is shown an alternative embodiment 50 of the present invention further including an o-ring seal 52 with a back-up ring 54 for providing greater bi-directional sealing at the rear seal 36, common reference numerals representing identical or substantially similar components as hereinabove discussed in connection with the embodiment 10.

FIG. 3 illustrates another embodiment 60 of the present invention in which a backup ring 62 is coupled to a rear lip seal 64 to prevent separation therebetween.

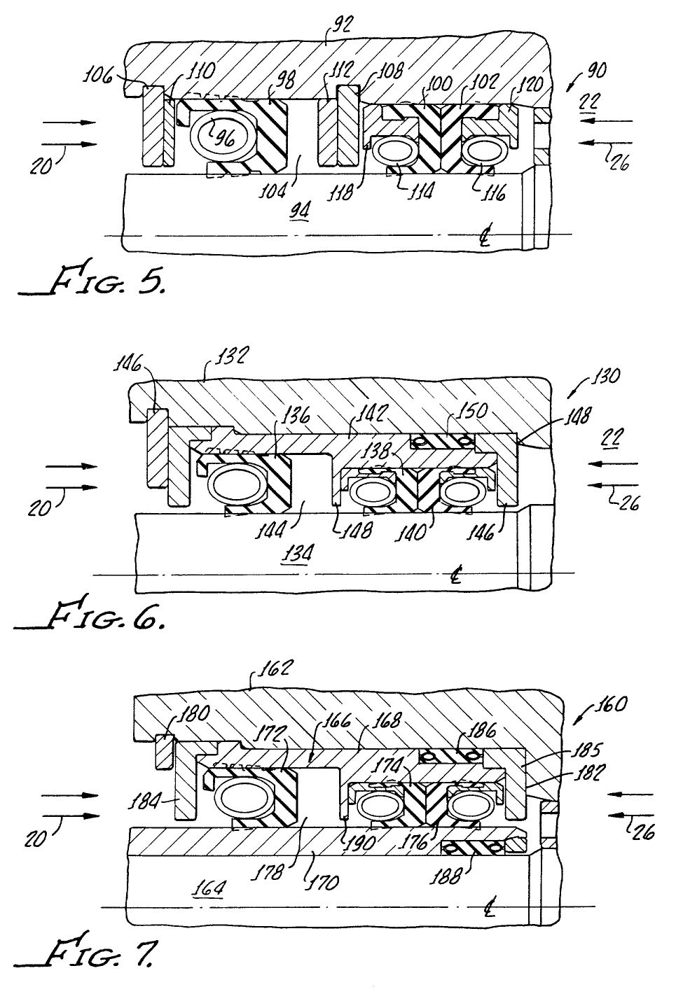

FIG. 4 shows another embodiment 70 of the present invention which utilizes two back-to-back lip seals 72, 74 which include a snap attachment 76, 78 on bodies 80, 82 of the seals 72, 74 for providing stability and providing bi-directional sealing against forces as indicated by the arrows 20, 26.

With reference to FIG. 5, there is shown another embodiment 90 of a media isolating seal system between a housing 92 and a solid shaft 94 utilizing a spring 96 energized floating lip seal 98 and a pair of back-to-back rear seals 100, 102 disposed in a spaced apart relationship with the floating seal 98 and a lubricating fluid 104 therebetween. Spiral retaining rings 106, 108 are provided for stabilization of the seals 98, 100, 102 respectively along with washers 110 utilized for determining the force deflection characteristics of the springs 114, 116.

FIG. 6 shows yet another embodiment in 130 of the present invention for providing a media isolation seal between a housing 132 and a shaft 134 which includes a floating seal 136 and two rear lip seals 138, 140.

In this embodiment 130, a cartridge 142 is provided for supporting the floating seal 136 and a rear seals 138, 140 in a spaced apart relationship with a lubricating fluid 144 therebetween and a retaining ring 146 is provided along with a shoulder 148, in the housing 132, for preventing the longitudinal movement of the system 130 along the shaft 134. A barrier 146 supported by the cartridge 142 retains the rear seals 138, 140 against a depending member 148. Further a static seal 150 may be provided between the cartridge 142 and a housing 132.

With reference to FIG. 7, there is shown another embodiment 160 of the present invention for sealing between a housing 162 and a shaft 164 utilizing a cartridge 166 with a housing portion 168 and a sleeve portion 170 portion 168 for supporting a floating seal 172 in a spaced apart relationship with rear seals 174, 176 and a lubricating fluid 178 therebetween. A retaining ring 180 and a shoulder 182 provide stabilization of the seal 160 between the bushings 184, 186. A depending member 190 provides for the capture of the rear seals 170, 176 between the bushing 186 and shoulder 184.

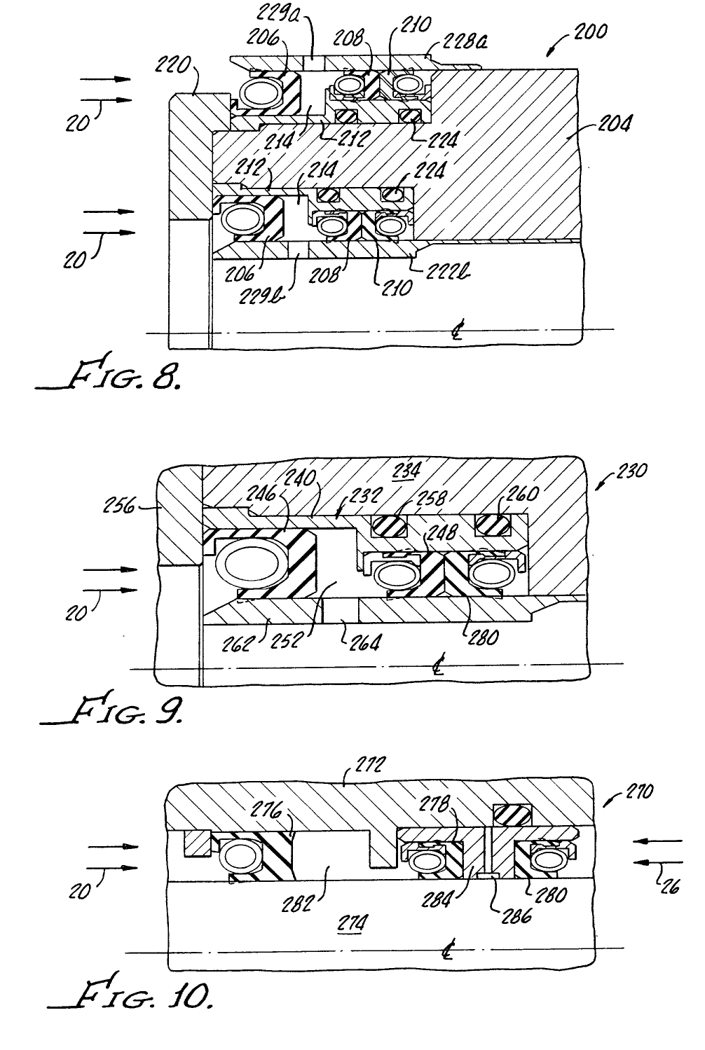

With reference to FIG. 8, there is shown another embodiment 200 of the present invention for sealing between a piston (not shown) and a housing 204 utilizing the floating seals 206 spaced apart from rear seals 208, 210 by a cartridge 212 with a center lubricating fluid 214 therebetween. A retaining plate 220 maintains the cartridge 212 with seals 206, 208, 210 in place. A static seal 224 is provided between the housing 204 and the cartridge 212. As shown shipping bushings 228a, 228b may be provided in order that the embodiment 200 can be prelubed via ports 229a, 229b the embodiment may be slipped out of the bushings 228a, 228b and mated with a piston or gland (not shown). The embodiment 200 as shown can be used on an ID or OD with either surface being dynamic or static. Accordingly, the real technology in accordance with the present invention is applicable for both dynamic and static sealing is provided for maintaining the seals 206, 208, 210 within the cartridge 212.

FIG. 9 shows yet another embodiment 230 in accordance with the present invention utilizing a cartridge 232 between a housing 234 and a shaft 236 which includes a housing member 240 for supporting a floating seal 246 in a spaced apart distance from rear seals 248, 250 with a lubricating fluid 250 therebetween. A barrier 256 retains the cartridge 232 and o-rings 258, 260 to provide a static seal between the housing portion 240 and the housing 234. As is the case with embodiment 200, a shipping bushing 262 with port 264 for prelubing the seal.

FIG. 10 shows another embodiment 270 in accordance with the present invention for sealing between a housing 272 and a shaft 274 which provides for a floating seal 276 and two rear seals 278, 280, held in a spaced apart relationship with a lubricating fluid 282 therebetween. A floating cartridge 284 with a vent 286 therethrough is provided in order to prevent any residual pressure between the seals 278, 280 as the pressure direction changes from one direction indicated by the arrows 20 to the other direction indicated by the arrows 26.

With reference to FIG. 11, there is shown another embodiment 290 of the present invention for providing a seal between housing 292 and a shaft 294 utilizing a floating seal 296 and a plurality of rear seals 298, 300, 302 disposed in a tandem relationship with one another and in a spaced apart relationship with the floating seal 298 with a lubricating fluid 306 therebetween. The tandem seal arrangement provides a longer sealing life with redundant reliability. Retaining rings 310, 312, and 314 provides stabilization of the seals between the housing 292 and shaft 294.

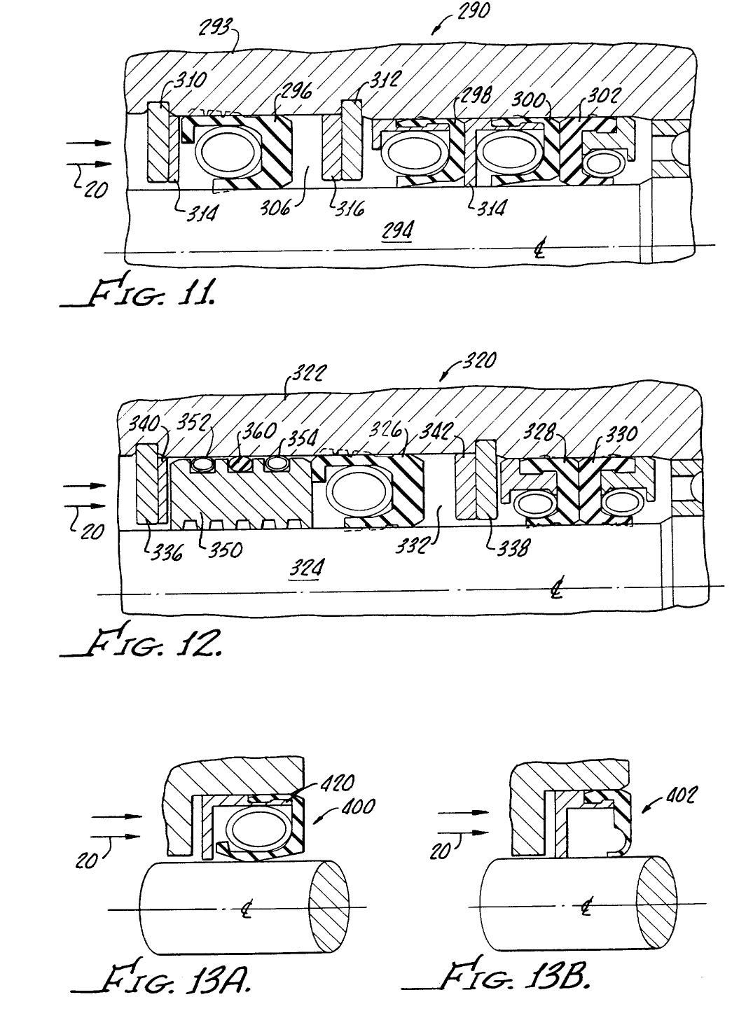

FIG. 12 shows further embodiment 320 of the present invention for sealing between a housing 322 and a shaft 324 which includes a floating lip seal 326 in a spaced apart relationship between rear seals 328, 330 with a lubricating fluid 332 therebetween and held by a retainer ring 336, 338 and washers 340, 342. Also included is a floating labyrinth clearance seal 350 stabilized between the housing 322 and shaft 324 by springs 352, 354 with an o-ring seal 360 disposed between the labyrinth seal 350 and the housing 320. The labyrinth seal provides for still longer seal life of the system 320.

FIGS. 13A-13G show typical variations of seals 400-410 which can be substituted in place of the rear seals shown in FIGS. 1-12. The seal for 12 shown in FIG. 13H can be used in place of the floating seal there shown in FIGS. 1-12. Alternate spring energizers 420, 424, 426, 428, 430, 432 may be utilized in any of the seals hereinabove described.

Although there has been hereinabove described a media isolation seal system in accordance with the present invention for the purpose of illustrating the manner in which the invention may be used to advantage, it will be appreciated that the invention is not limited thereto. Accordingly, any and all modifications, variations, or equivalent arrangements which may occur to those skilled in the art, should be considered to be within the scope of the invention as defined in the appended claims.

What is claimed is:

1. A media isolation seal system for sealing between a housing and a shaft to prevent passage of pressurized abrasive media, the system comprising:
a floating seal, disposable between the housing and the shaft, for contacting the pressurized abrasive media and preventing passage of the media thereby;
a rear seal disposable between the housing and the shaft at a spaced apart distance from said floating seal; and
a lubricating fluid disposed between said floating seal and said rear seal for transferring pressure to said rear seal and enabling said floating seal to have zero differential pressure thereacross.

2. The seal system according to claim 1 wherein said floating seal and said rear seal each comprise a spring loaded lip seal and each oriented between said housing and said shaft with lips facing the pressurized media.

3. The seal system according to claim 2 further comprising a second rear seal, disposed in an abutting relationship with said rear seal, for providing bi-directional sealing at a rear seal position.

4. The seal system according to claim 3 wherein said second rear seal comprises an O-ring seal.

5. The seal system according to claim 4 further comprising a back-up ring disposed between said O-ring seal and said rear seal.

6. The seal system according to claim 3 wherein said second rear seal comprise a second spring loaded lip seal.

7. The seal system according to claim 6 further comprising retaining rings disposed between said housing and said shaft for preventing longitudinal movement of said floating seal and said rear seal.

8. The seal system according to claim 6, wherein the spring loaded lip seals are oriented back-to-back with each lip seal having lips extending in opposite direction, said lips seal being snapped together.

9. The seal system according to claim 1 wherein said rear seal comprises a plurality of individual seals in tandem.

10. The seal system according to claim 9, wherein each of the individual seals are spring loaded lip seals.

11. The seal system according to claim 1 further comprises a floating labyrinth clearance seal disposed on a pressure side of said floating seal.

12. A media isolation seal system for sealing between a housing and a shaft to prevent passage of pressurized abrasive media, the system comprising:
a floating seal disposed between the housing and the shaft, for contacting the pressurized media and preventing passage of the media thereby;
a rear seal disposed between the housing and the shaft;
a cartridge for supporting said floating seal and said rear seal in a spaced apart relationship; and
a lubricating fluid disposed between said floating seal and said rear seal for transferring pressure to said rear seal and enabling said floating seal to have zero differential pressure thereacross.

13. The seal system according to claim 12, wherein said cartridge includes a housing portion and snap-on washer for securing the housing portion to said housing.

14. The seal system according to claim 13 wherein said cartridge includes a sleeve portion for abutting said shaft.

15. The seal system according to claim 12 wherein said floating seal and said rear seal each comprise a spring loaded lip seal and each oriented between said housing and said shaft with lips facing the pressurized media.

16. The seal system according to claim 15 further comprising a second rear seal, disposed in an back-to-back relationship with said rear seal, for providing bi-directional sealing at a rear seal position.

17. The seal system according to claim 16 wherein the rear seal and second rear seal are in an abutting relationship.

18. The seal system according to claim 17 wherein said second rear seal comprises an O-ring seal.

19. The seal system according to claim 18 further comprising a back-up ring disposed between said O-ring seal and said rear seal.

20. The seal system according to claim 16 wherein said second rear seal comprise a second spring loaded lip seal.

21. The seal system according to claim 20 further comprising retaining rings disposed between said housing and said shaft for preventing longitudinal movement of said floating seal and said rear seal.

22. The seal system according to claim 20, wherein the spring loaded lip seal are oriented back-to-back with each lip seal having lips extending in opposite direction, said lips seal being snapped together.

23. The seal system according to claim 12 wherein said rear seal comprises a plurality of individual seals in tandem.

24. The seal system according to claim 23, wherein each of the individual seals are spring loaded lip seals.

25. The seal system according to claim 12 further comprising a floating labyrinth clearance seal disposed on a pressure side of said floating seal.

26 The seal system according to claim 16 further comprising a vent disposed in said cartridge for relieving pressure between.
